(19) United States
(12) Patent Application Publication
(10) Pub. No.: US 2011/0240440 A1
(43) Pub. Date: Oct. 6, 2011

(54) INTERMEDIATE STORAGE

(75) Inventor: Kurt Philipp, Grenzach-Wyhlen (DE)

(73) Assignee: ROTZINGER AG, KAISERAUGST (CH)

(21) Appl. No.: 13/140,661

(22) PCT Filed: Dec. 17, 2009
(86) PCT No.: PCT/EP09/67435

§ 371 Date: Jun. 17, 2011

(30) Foreign Application Priority Data
Dec. 17, 2008 (CH) 01982/08

(51) Int. Cl. B65G 37/00

(52) U.S. Cl. 198/347.1

(57) ABSTRACT

The invention relates to an intermediate storage (1) for products (135), comprising an input station (2) and an output station (3), a closed, conveyor path disposed between the input and the output station, wherein by way of conveying gondolas (13) that circulate around the conveyor path, the products (135) can be conveyed between the input and the output station, wherein the conveying gondolas (13) can be moved by one or more conveying means (12, 12′) of the conveyor path and wherein the output station (3) comprises a moveable ejector (341) for ejecting one or more products (135) from the conveying gondolas (13) and a holding device (31) for holding the ejected products (135), wherein the conveyor path comprises an upwardly-leading path section at the output station (3) with a vertical upward motion of the conveying gondolas, wherein the ejector (341) and the holding device (31) are disposed laterally opposite to one another on the path section, and wherein the ejecting by the ejector (341) comprises a horizontal and reverse movement that is synchronized with the vertical upward movement of the conveying gondolas (13) in the upwardly-leading path section.

The invention relates to an intermediate storage in accordance with the preamble of the independent Claim 1 and a corresponding method.

### DESCRIPTION

The prior art describes general cargo or hanging storage devices, in particular for foodstuffs, and primarily for chocolate bars or similar products. DE 695 01 866 T2 discloses a hanging storage that envisions the products being supported on plates which are disposed horizontally on swings, held horizontally and parallel relative to each other by two chains and moved along a closed circulation between an input and an output station, and wherein at the location of the output station at least one device comprising a cam-controlled ejection device with at least one stamp for ejecting the products from the plates onto a conveyor belt is disposed downstream of the output station, and wherein the ejection device is essentially movable in the horizontal and vertical directions. In the hanging storage as specified in DE 695 01 866 T2 the swings in the circulation are guided vertically past the output station from above to below. By coupling two stamps it is further proposed to empty two plates or trays that are loaded with products simultaneously, and wherein the products are unloaded onto separate conveyor belts respectively. One disadvantage of the proposed ejection of products lies in the fact that high cycle rates during permanent operation are achieved only if the subsequent conveyor belts are configured as vertically height-adjustable. This is necessary because the gondolas for increasing the ejection cycle must be continually guided past the output station without ever stopping. Since the gondolas are transported from top to bottom for unloading, collisions of the stamp with the conveyor belt may occur during the ejection process. This problem is remedied via vertical tracking by the conveyor belt. But it is disadvantageous that the belt and the pestle must always be returned to the upper output position resulting in undesirable dead times and an irregular unloading process. Moreover, the movable parts are subject to higher wear and tear. In addition, controlling and operating the unloading device is complex, further resulting in higher maintenance and thereby additional expenditures. The disadvantages of this apparatus also become clear due to the fact that during the step-wise unloading the gondola that is to be unloaded is brought to a halt during the ejection process and cannot be transported further until the pestle or ejection device is withdrawn and/or retracted from the conveyor belt. The ejection device thus intermittently blocks the transportation of the gondolas. A further disadvantage is the fact that the cam-controlled ejection device comprises a predetermined and therefore limited area of play, which creates the need for re-dimensioning of the device, for example, during the ejection process at high cycle rates resulting in higher costs.

Document U.S. Pat. No. 1,837,605 describes an intermediate storage having a multitude of continuously circulating conveyors, and wherein each of the conveyors is separated from the respective conveyors preceding and succeeding it by a descending glide area. This causes the conveyor frames to circulate not inside a closed conveyor path but a path comprising individual conveyors that are connected to each other by glide areas and conveyor paths that are implemented by conveyor frames, and wherein in the glide areas the conveyor frames are transported by the force of gravity. At the input station of the intermediate storage the conveyor frames are transported in an upward direction and loaded with products. At the output station of the intermediate storage the conveying frames are also transported in an upward direction. The disadvantage of this intermediate storage lies in the fact that a conveyor frame must be transported at the same speed at the input and output stations that are at a distance of only the distance of one tray relative to each other.

Document U.S. Pat. No. 5,350,050 A discloses a vertical elevator conveyor apparatus having several pairs of roller chains that are driven by drive sprockets and disposed upon which are horizontal support areas that are movable in a vertical direction, whereby a load can be loaded at any desired position along the vertical path of the elevator conveyor apparatus onto a conveying device of a storage step of an accumulator or unloaded from the latter onto an elevator conveyor apparatus in that the load is horizontally ejected onto the support area of the elevator conveyor apparatus or off said apparatus. One of the disadvantages of this invention lies in the fact that the device, which is configured for very large and heavy products, is not suitable for high cycle rates. The unloading conveyor device usually works at a low speed. It is also disadvantageous that the different storage steps often have gaps in how they are loaded with products. Also disadvantageous, furthermore, is the complex controlling for loading and unloading of products to and from the storage steps by way of the respective elevator conveyor apparatuses that always convey products in an upward direction in the input area of the accumulator and in a downward direction in the output area of the accumulator.

The object of the present invention therefore envisions providing a method for unloading products and a corresponding storage that does not suffer from the disadvantages of the current state of the art, in particular, having instead an efficient unloading apparatus that is subject to minimal wear and tear and operates cost-efficiently while meeting high performance requirements.

According to the invention this object is achieved with an apparatus and a corresponding method as set forth in the independent Claim 1. Advantageous improvements of the storage according to the invention are set forth in the dependent claims.

Specifically, these objects are achieved by the invention in that an intermediate storage is provided for products having an input station and an output station with a closed conveyor path disposed between the input and output stations, and wherein the products can be conveyed between input and output stations by the conveying gondolas that run along a circular path, and wherein the conveying gondolas can be moved by one or more conveying means, and wherein the output station comprises a movable ejector for ejecting one or several products from the conveying gondolas as well as a holding device for receiving the ejected products, and wherein the conveyor path comprises at the input station a descending path section with a vertical downward movement during operation of the conveying gondolas that are to be loaded with products by way of the input station, and wherein the conveyor path comprises an ascending path section with a vertical upward movement of the conveying gondolas at the output station, and wherein the ejector and the holding device are disposed laterally opposite relative to each other on the path section, and wherein the ejection action of the ejector comprises a horizontal forward and reverse movement that is synchronized with the vertical upward movement of the conveying gondolas in the ascending path section.

Due to the vertical movement by the ejector that is synchronized with the upward movement by the conveying gondolas, it is possible to start the upward movement of the conveying gondolas at an earlier time, for example at the point in time when the ejector has reached its front ejection position. An essential advantage of this apparatus indeed lies in the fact that the ejection performance and/or the number of ejection cycles can be increased by up to 30% relative to known solutions as set forth in the prior art. The prior art requires that the holding device, for example the conveyor, is vertically moved along with the ejector, as described above, because the conveying gondolas are moved from top to bottom at the output station. In the proposed unloading system the transporting of the conveying gondolas 13 occurs from bottom to top in the area of the output station 3 allowing for the ejector, which is extracted at position W₂, to easily and synchronously move upward along with the conveying gondola 13. In this, the ejector 341 is able to remain in position W₂ at least temporarily. This constitutes the basis for the ability of any and all conveyors and/or ejection belts to stay fixed in a stationary, horizontal position. Consequently, no conveyor obstructs the way of the ejector 341, which is to be moved vertically upward.

The solutions according to the prior art do not allow for leaving the holding device in a stationary position because when in its front position W₂ the ejector is located above the holding device, for example a conveyor, which would mean a synchronous downward movement by the ejector 341 and the conveying gondolas 13 would be blocked. The invention includes the advantage that the holding device does not have to be moved together with the conveying gondola. This creates a considerable cost advantage because it is possible to forego certain movable parts, such as a lift apparatus for the receiving device. The invention includes the further advantage that the products that are ejected onto the holding device do not have to be accelerated vertically, while they are being conveyed to a packaging machine. Moreover, at least one so-called bent transition from one holding device to another subsequent holding device is omitted, for example in cases when the holding device is implemented as a conveyor and/or conveyor belts.

Conveying objects and/or products are conveyed from an input station, using conveying object supports, along a conveyor path to an output station in order to be unloaded at that location. Conveying objects are arranged at vertical distances relative to each other along a vertically ascending path section of the conveyor path at the output station. Conveying objects are transferred by means of a horizontally movable ejector from the output station to a vertically immovably disposed holding device for the purpose of unloading, and wherein the ejector is able to move horizontally and/or vertically. At the output station, for the purpose of the transfer from the conveying object support to the holding device, the conveying objects are transferred by way of a horizontal and/or vertical ejection movement by the ejector, and wherein the ejection movement by the ejector is synchronized in terms of timing with the upward movement of the conveying object supports in the ascending path section.

Consequently, using the apparatus according to the invention allows, in particular, for an efficient unloading process, which results in an increase of the unloading performance in contrast to the known solutions.

In one variant of an embodied example of the intermediate storage the conveyor path comprises in the area of the ascending path section a lateral path (X) between ejector (341) and holding device (31), and wherein the horizontal forward and reverse movements in the area of the path (X) can be synchronized with the ascending path section. The invention includes the advantage that the conveying gondola from which, using the ejector, products have been ejected onto the holding device can be set in an ascending motion immediately, even if the ejector is still completely extracted and/or still dwelling in its end position. But now, simultaneously with the vertical upward movement by the conveying gondola, it is possible to set the ejector in a reverse motion. As soon as the nose of the ejector exits the conveying gondola, the vertical downward movement of the ejector can be executed until the ejector has been returned to its starting position.

In another variant of an embodied example of the intermediate storage the upward movement by the conveying gondolas in the ascending path section can be executed as continuous. The invention includes the advantage that the synchronization of the horizontal forward and reverse movements by the ejector can be synchronized with the vertical upward movement by the conveying gondolas in such a way that the conveying gondolas, even for the purpose of ejecting the products, no longer have to be brought to a standstill. However, to allow for a gentle ejectability of the products it is possible to provide for a slow-down of the upward movement by the conveying gondolas during the ejecting action. But as soon as the products have been placed on the holding device, which is laterally disposed relative to the conveying gondola, it is possible to return the gondola to a faster upward movement. Looking at this state, which is to be designated as the ejection end position, in a top view of the apparatus, the nose or tip of the ejector itself, which normally makes contact with the products during the ejection action, is still located above the holding device. The upward movement by the gondola can be continued already in this state in order to accelerate the unloading cycle. During the upward movement the ejector is vertically taken along with the conveying gondola and returned in a reverse movement to its horizontal starting position.

In a further variant of an embodied example of the intermediate storage the upward movement of the conveying gondolas can be executed as discontinuous in the ascending path section. The invention includes the advantage that the conveying gondola can be brought to a halt, for example, for products that must be ejected especially gently. But the gondola can be returned to an upward movement as soon as the products have been placed upon the holding device that is disposed laterally of the conveying gondola. Returning the ejector to its starting position can occur analogous to the aforementioned process.

In one variant of an embodied example of the intermediate storage the holding device is implemented as a conveyor with a continuous circulating belt for receiving the ejected products and transferring the products to a processing station, and wherein the conveyor is rigidly disposed on the output station. The invention includes the advantage that, due to the rigid arrangement of the holding device that is implemented as a conveyor, it is possible to forego movable means, for example drive mechanisms and levers that must be controlled. On the one hand, this allows for a more cost-effective implementation of the intermediate storage; moreover, any maintenance of such a drive mechanism or such levers is omitted. Moreover, it is possible to simplify the control of the intermediate storage. A rigid installation, furthermore, increases the reliability of the storage and/or the intermediate storage.

In another variant of an embodied example of the intermediate storage the output station comprises a multitude of ejectors for ejecting the products and a multitude of the corresponding conveyors for receiving the products, and wherein the horizontal forward and reverse movements by each ejector is implemented independently relative to the horizontal forward and reverse movements by each of the other ejectors. The invention includes the advantage that it is possible to eject products from a conveying gondola employing several ejectors, thereby achieving more efficient unloading. A conveying gondola can comprise one or several storage areas, trays, plates or supports. Each tray can hold one or several products. Several products on a single tray are usually arranged in rows, most often in rows of one. It is also possible to carry the products along on a gondola and/or a tray without any special arrangement. Each ejector is allocated to at least one holding device, for example one conveyor. Each conveyor can supply, for example, a separate packaging machine with the ejected products.

In a further variant of an embodied example of the intermediate storage the holding device for receiving the products is implemented as a plate, and wherein the plate can be pivoted or tilted relative to a processing station in order to release the products. The invention includes the advantage that a plate is disposed on the intermediate storage with the ability to pivot or tilt vertically, whereby products that have been ejected onto the plate can be released to a conveyor, container, machine or something similar. The pivoting usually occurs around a swing axis, and wherein the axis can extend parallel relative to the ejection edge and/or the edge area of a gondola or a tray.

In one variant of an embodied example of the intermediate storage the holding device comprises plates and conveyors for receiving the products. The invention includes the advantage that conveyors, which are disposed in a horizontally rigid position, ensure optimum friction between the ejected products and the conveyor belt. This is especially necessary in instances when products must be transported at a high speed to the packaging machine downstream. Correct friction is needed to ensure that, in as much as possible, the gaps and/or distances between individual products remain unchanged. A horizontal and rigidly disposed conveyor path is especially optimally suited for this purpose.

In another variant of an embodied example of an intermediate storage the conveying means are implemented as continuous chains and/or continuous belts. The invention includes the advantage that the conveying gondolas can be directly attached to the conveying means by way of coupling elements and without any need for further guide or transportation rails or cables.

A further variant of an embodied example of the intermediate storage provides that each chain can be driven by at least one drive mechanism or shaft, and wherein the drive and/or each drive is controllable and/or adjustable by a control. The invention includes the advantage that central drive mechanisms can be utilized for conveying a multitude of conveying gondolas that are disposed on the chains.

In one variant of an embodied example of the intermediate storage the synchronization of the vertical upward movement by the conveying gondolas in the ascending path section is implemented by a control, and wherein sensor means are provided for the ascending path section by way of which it is possible to detect the overlap of the ejector with the path length. The invention includes the advantage that sensor signals by sensor means can be interpreted by the control. For example, this allows an intermediate storage that has been taken in operation to respond with more ease to exceptions or peculiarities during the transportation of, for example, different products. Sensor means can be, for example, optical, inductive, capacitive or magneto-resistive sensors.

In one variant of an embodied example of an intermediate storage the synchronization of the vertical upward movement by the conveying gondolas in the ascending path section is implemented by means of a cam control. The invention includes the advantage that the output station can be implemented even in a rough production environment.

In one variant of an embodied example of the intermediate storage, during the ejection movement by the ejector, the conveying object support is moved upward in the ascending path section at a continuous first conveying speed. The invention includes the advantage that with a constant upward movement the conveying objects can be conveyed smoothly by means of conveying gondolas and/or conveying object supports. Moreover, the control or adjustment of the drive mechanism of the conveying gondolas is simplified in this area. To achieve a gentle treatment of the products during the ejection process even at maximum conveying speed the ejection movement by the ejector is optimized in such a way that the ejection action is initiated even before the product reaches the ejection level of the holding device. The ejection level is reached when the product or object can be transferred horizontally to the holding device of the output station.

In another variant of an embodied example of the intermediate storage, during the ejection movement by the ejector, the conveying object support is conveyed at a second conveying speed in the ascending path section in order to be conveyed at the first conveying speed after the completion of the ejection action of the object, and wherein the first conveying speed is larger than the second conveying speed, and wherein the second conveying speed is larger than zero. The invention includes the advantage that a conveying object and/or product that is to be unloaded is guided past the area of the holding device for an extended period of time. This leaves relatively more time for a gentle ejection process, which may be indicated, for example, for fragile products such as baked goods.

In another variant of an embodied example of the intermediate storage, during the ejection movement, the conveying object support is temporarily brought to a halt in the ascending path section of the output station, whereby the second conveying speed is zero. This variant of an embodied example is especially advantageous if fragile conveying objects and/or products must be unloaded and/or if products are located only at a minimal vertical distance relative to each other, for example, because trays or support areas of the object conveyor are disposed as closely relative to each other as possible in order to convey and or store in the intermediate storage a number of products per object support that is as large as possible.

Subsequently, the invention will be illustrated in further detail using the embodiments depicted in the drawings. The drawings and their descriptions disclose further essential characteristics and advantages of the invention.

FIG. 1 shows a schematic and simplified representation of the general cargo storage according to the invention that is disposed between a production apparatus and a processing apparatus, and wherein the processing apparatus is usually configured as a packaging machine;

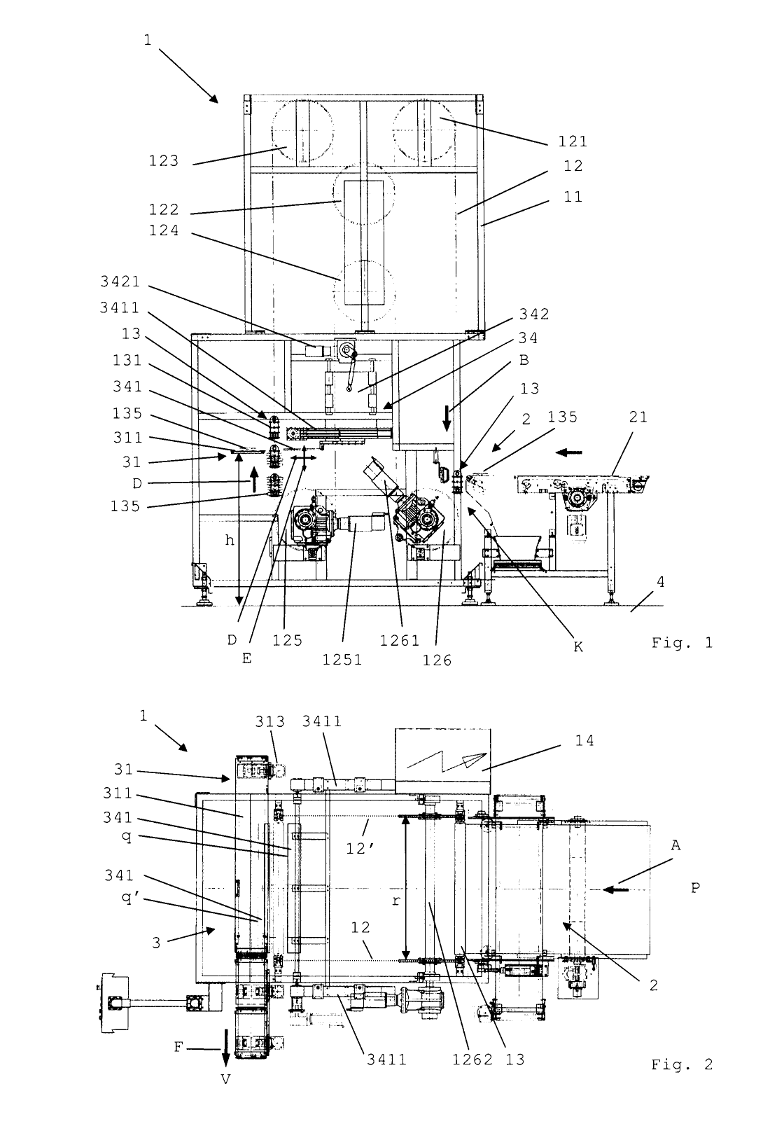

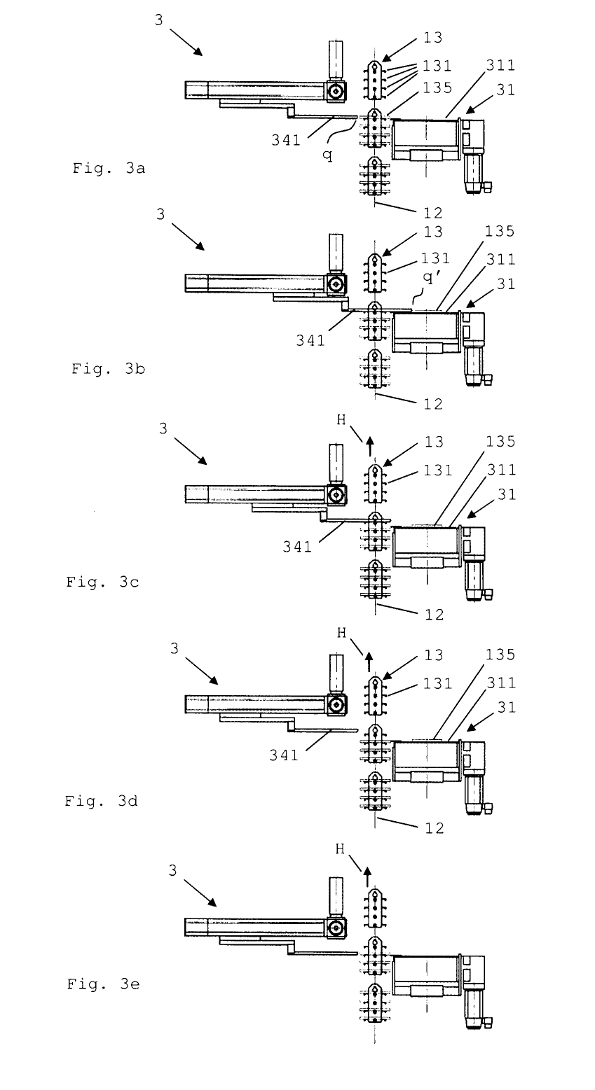

FIG. 2 shows a top view of a schematic and simplified representation of an intermediate storage;

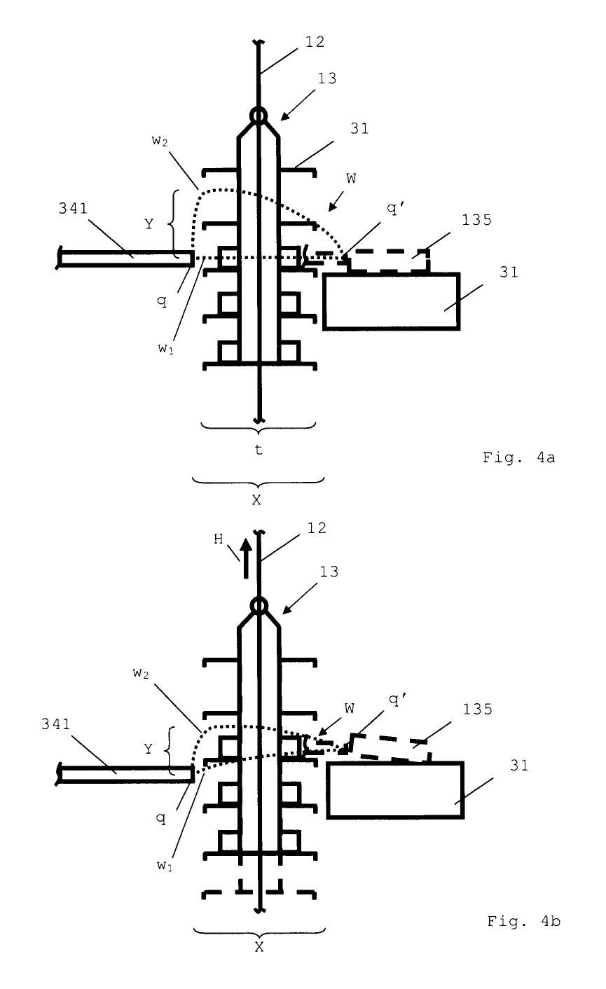

FIGS. 3a to 3e show by way of a detail of FIG. 1 the output station of the intermediate storage, and wherein products are ejected from a gondola onto a conveyor;

FIG. 4a shows by way of a detail of FIG. 1 the output station of the intermediate storage, and wherein a conveying gondola is conveyed by a discontinuous upward movement in a path section of the conveyor path; FIG. 4b shows the conveyance of the conveying gondola in a continuous upward movement;

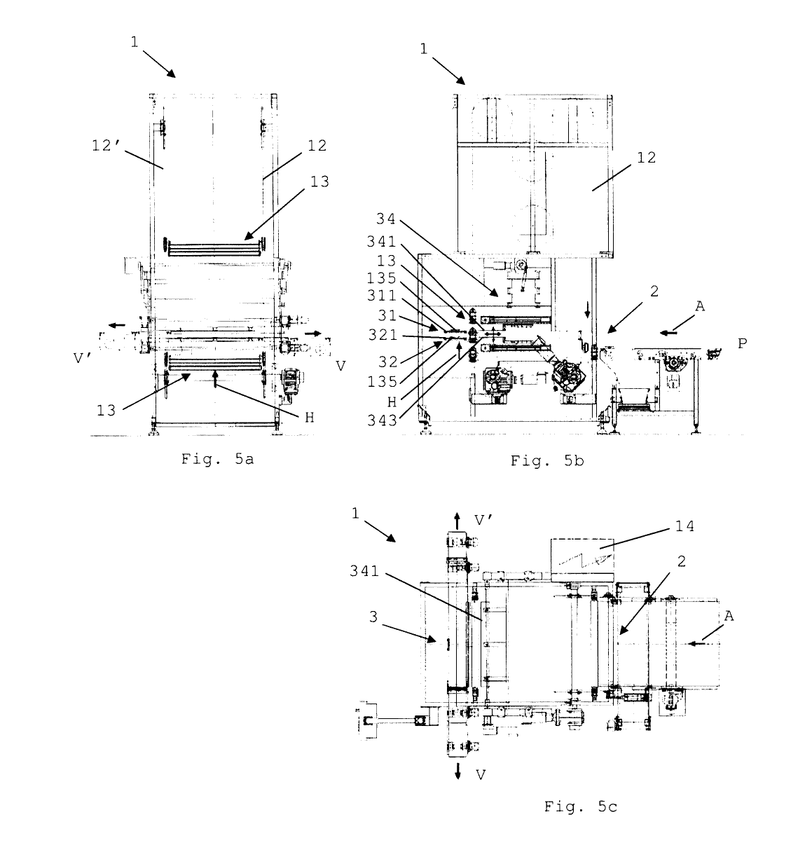

FIGS. 5a to 5c show a further embodied example of the apparatus according to the invention, and wherein the products from the intermediate storage are ejected onto two conveyors that supply one packaging machine respectively;

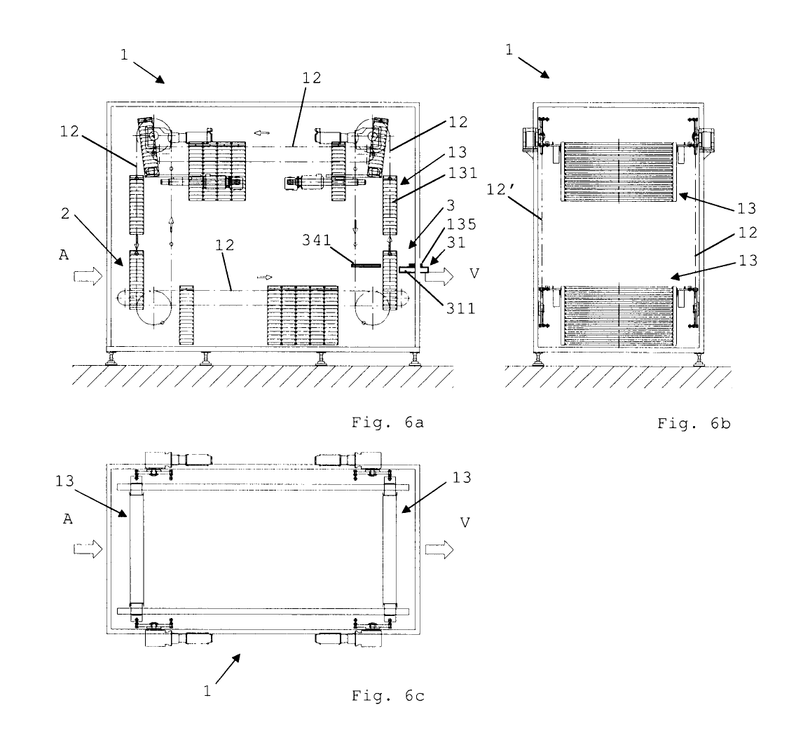

FIGS. 6a to 6c show a further embodied example of the apparatus according to the invention.

FIG. 1 illustrates an intermediate storage 1 for conveying objects and/or products 135 having an input station 2 and an output station 3. A closed conveyor path is disposed between the input and output stations. By conveying gondolas 13, circulating around the conveyor path K, the products 135 can be conveyed between the input and output stations. The conveyor path K is configured as a circular or loop-shaped path. The conveyor path K has a certain length along which each of the conveying gondolas 13 is conveyed. The conveyor path K is preferably a closed system. During operation, conveying gondolas or conveying object supports 13 are conveyed on each conveyor path section of the conveyor path in the conveying direction or against the conveying direction in a controlled fashion. There are no conveyor path sections that are equipped with slides or something similar. The conveying gondolas 13 are movable by one or several conveying means 12, 12′ of the conveyor path. The output station 3 comprises a movable ejector 341 for ejecting one or several products 135 from the conveying gondolas 13 and a holding device 31 for receiving the ejected products 135. At the output station 3 the conveyor path comprises an ascending path section with a vertical upward movement of the conveying gondolas. The ejector 341 and the holding device 31 are disposed laterally opposite relative to each other on the path section. The ejection action by the ejector 341 comprises a horizontal forward and reverse movement that is synchronized with the vertical upward movement by the conveying gondolas 13 in the ascending path section. The conveyor path comprises in the area of the ascending path section a lateral path, which is designated as path X in FIGS. 4a and 4b and located between the ejector 341 and the holding device 31, and wherein the horizontal forward and reverse movement in the area of path X can be synchronized with the ascending path section.

The upward movement by the conveying gondolas 13 can be executed as continuous in the ascending path section. The upward movement by the conveying gondolas 13 in the ascending path section can be executed as discontinuous. The holding device 31 can be implemented as a conveyor with a circulating conveying belt 311 for receiving the ejected products 135 and for the release of the products to a processing station V, and wherein the conveyor is rigidly disposed at the output station 3. It can be disposed, for example, at a height h. The output station 3 can comprise a multitude of ejectors 341,342 for ejecting the products 135 and a multitude of corresponding conveyors 31, 32 for receiving the products. The horizontal forward and reverse movement of each ejector 341, 342 therein is implemented as independent relative to the horizontal forward and reverse movements of each of the other ejectors. The holding device 31 for receiving the products 135 can be implemented as plate 311, 321, and wherein the plate can be configured as having the ability to pivot or tilt for releasing the products to a processing station V. The holding device 31 can comprise plates and conveyors for receiving the products 135. The conveying means 12, 12′ are usually implemented as continuous chains and/or continuous belts. In this context, the chains are disposed, for example, as circulating via sprockets. Each chain 12, 12′ can be driven by at least one drive mechanism 1251 or shaft. The drive and/or each drive is/are controllable and/or adjustable by a control 14. The synchronization of the vertical upward movement by the conveying gondolas 13 is implemented in the ascending path section, for example by way of a control 14, and wherein sensor means are provided along the ascending path section by which it is possible to detect the overlap of ejector 341 with the path X. Designated as overlap is how in a top view, during the ejection action and reverse movement to the starting position, the ejector 341 forms a surface or an intersection with the storage area 131. This applies provided the ejector is configured as a flat-shaped element. The ejector 341 can also, for example, be implemented as an element having finger-type pestles or as an element with a narrow board that comes into contact with the product. An overlap occurs in these instances as well. The synchronization of the vertical upward movement of the conveying gondolas 13 in the ascending path section can be implemented, for example, by way of a cam control.

An ejection process of an intermediate storage 1 can be configured in such a way that the conveying gondolas 13 are moved continuously along the conveyor path, that the ejector 341 is held in a starting position w₁ of a path length W, that products 135 are ejected at the output station 34 by way of the ejector 341 from the conveying gondola 13 onto the holding device 311, that following the ejection action of the products the ejector 341 is brought into a vertical upward movement that is synchronous to the conveying gondolas 13 and in a horizontal movement in order to return to the starting position w₁ after having traveled the path length W in order to allow for further products to be ejected. An ejection cycle can also be configured in such a way that the conveying gondolas 13 are conveyed discontinuously along the conveyor path, and wherein, during the ejection action of the products 135 the conveying gondola that is to be unloaded is brought to a halt, and wherein, following the completed ejection action, the upward movement by the conveying gondola is continued.

FIG. 2 shows a top view of a schematic and simplified representation of the intermediate storage 1. Reference sign P designates a production system, not depicted here, that produces the products 135. By conveying means, which are also not shown here, the products are conveyed in the direction of the arrow A to the input station 2. At input station 2 the conveying gondolas 13 are loaded with the products 135. By way of the intermediate storage 1 a decoupling of the production P from the—not shown—packaging and/or processing station V is thus achieved. At the output station 3 the intermediately stored products 135 are ejected by the ejector 341 onto the holding device 31. Afterwards the holding device 31 transports the products in the direction of the arrow F to the packaging station V for further processing. The reference sign 14 designates the control of the intermediate storage. The control can be disposed centrally inside a cabinet at the intermediate storage. The control serves, in particular, for controlling the drive mechanisms for the input station 2, the conveyor path and the output station 3. The drive mechanisms can be implemented as electrical motors with and without transmission. Drive mechanisms can be implemented as linear motors. Drive mechanisms can be implemented as pneumatic or hydraulic push cylinders. The control 14 can also be supplied with signals from sensor means in order to optimize the control of the drive mechanisms and/or drive means or to adjust it/them to changed operating conditions, for example temperature fluctuations or wear and tear on machine parts. FIG. 2 shows a shaft or axle that is designated by reference sign 1262. The shaft is driven by a drive mechanism that is controlled and/or adjusted by control 14. Two wheels are disposed on the shaft, for example sprockets. In FIG. 1 such wheels are shown in a side view. FIG. 1 also shows how a continuous chain, belt or strap is disposed as circulating several wheels 121,122,123,124,125,126. In the shown variant of an embodied example the intermediate storage 1 has two circulating chains that are not shown here. In FIG. 2 it can be seen that the chains 12, 12′ are disposed at the distance r relative to each other in the intermediate storage. The ejector 341 is shown in a starting position q, before products 135 are ejected from a conveying gondola 13, and an end position q′, after the products 135 have been ejected onto the holding device 31.

FIGS. 3a to 3e show by way of a detail of FIG. 1 the output station 3 of the intermediate storage 1, and wherein products 135 are ejected from a gondola and/or conveying gondola 13 onto a conveyor 31. Reference sign q designates in FIG. 3a the starting position of the ejector 341. In FIG. 3b the end position of the ejector 341 is designated by q′. FIGS. 3a to 3e show an unloading cycle and/or the process during the ejection action of products.

FIG. 4a illustrates an ejection cycle of products and/or conveying objects 135 from a conveying gondola and/or a conveying object support 13, and wherein the conveying gondola or gondola is brought to a halt during the ejection action. The conveying chain is not moved during the ejection action of the products 135 because the ejector penetrates the conveying gondola 13 that is to be instantaneously unloaded in order to eject the products onto the holding device. In solutions according to the prior art this intermediate halt is a necessary prerequisite for damage-free operation because the ejector would block the downward movement of the conveying gondolas at least for the process duration of the ejection action. However, the proposed invention envisions that the conveying gondolas 13 are moved upward at output station 3, as shown. An ejection cycle and/or unloading process comprises the following steps: the ejector remains in a starting position q, and wherein it performs a forward movement to traverse a path w₁ as soon as products 135 are positioned in front of the tip or nose of the ejector; the forward movement can be executed as linear or a non-linear in order for the products to be ejected as gently as possible onto the opposite holding device; during the ejection action an overlap occurs with the lateral extension of the path section of the conveyor path; this extension corresponds at least to the distance t and/or depth t of a conveying gondola 13; the forward movement is brought to a halt as soon as the products are completely stored on the holding device and the nose of the ejector and/or the part of the ejector that comes into contact with the product reaches its end position q′; since the conveying gondolas cannot the continuously transported during an unloading process of this kind, the corresponding amount of time is lost during the ejection cycle. When the position q′ has been reached the path length W₂ can be traversed in order to return to the starting position q. In total, the ejector traverses the path length W.

FIG. 4b illustrates an ejection action cycle of products 135 from a conveying gondola 13, and wherein the conveying gondola is not brought to a halt during the ejection action. The conveying gondola 13 can be transported at a decelerated speed along its upward direction during the ejection action. The upward movement is not interrupted therein. The speed is thus selected in such a way that it is not zero. Naturally, the drive mechanism of the conveying gondola 13 can be stopped for service and support. The continuous upward movement in the direction of the arrow H has the advantage that the products 135 are usually unloaded faster from the conveying gondolas as compared to if the conveying gondolas 13 are brought to a halt for each ejection process instance.

FIGS. 5a to 5c show a further embodied example of the apparatus according to the invention, and wherein the products of a conveying gondola 13 are ejected onto two conveyors 311,321, not shown in the figures, that supply a packaging machine V and V′ respectively.

FIGS. 6a to 6c show a further embodied example of the intermediate storage according to the invention having an input station 2 and an output station 3. In this instance, the intermediate storage 1 has several conveying means 12, 12′ that can be driven independently of each other. FIG. 6b depicts a side view of storage 1, and wherein some details from FIG. 6a are not shown here. FIG. 6c depicts a top view of storage 1, and wherein for reasons of a simplified representation certain details from FIG. 6a have been omitted. In the input station and output station 3 the conveying means 12,12′ are configured as chain conveyors for the vertical conveyance of the conveying gondolas 13. For the horizontal conveyance of the conveying gondolas 13 in so-called storage spaces the conveying means are configured as horizontal storage space conveyors. The intermediate storage comprises a storage space for empty gondolas that is arranged in the upper area of the storage 1. A further storage space is provided for gondolas 13 loaded with products 135, which is disposed at the bottom in the storage. In this embodied example as well, the conveying gondolas are moved at output station 3 from the bottom to the top, preferably in a vertical conveying direction. The conveying gondolas 13 that are loaded with products 135 are unloaded by ejector 341.

### LIST OF REFERENCE SIGNS

1 General cargo storage, storage, hanging storage, object storage
11 Frame, frame construction
12 Chain, conveying chain
12′ Chain, conveying chain
121 Sprocket, wheel
122 Sprocket, wheel
123 Sprocket, wheel
124 Sprocket, wheel
125 Sprocket, wheel
1251 Drive mechanism
126 Sprocket, wheel
1261 Drive mechanism
1262 Shaft
13 Conveying gondola, gondola, product support, conveying object support
131 Storage area, tray, plate
135 Product, general cargo, conveying object
14 Control, control unit, adjustment
2 Input station/entry station
21 Conveyor
3 Output station, exit station
31 Conveyor
311 Tray area
313 Drive mechanism
32 Conveyor
321 Storage area
323 Drive mechanism
34 Holding device
341 Ejector, ejecting device
3411 Drive
342 Lift device
3421 Drive mechanism
343 Ejector, ejecting device
3431 Drive
4 Mounting level, floor
A Arrow
B Arrow
C Arrow
D Arrow
E Arrow
F Arrow
G Arrow
H Arrow
h Distance
K Conveyor path
P Production station
q Starting position
q′ End position
r Distance
t Distance, depth
S1 First conveying speed
S2 Second conveying speed
V Processing station, packaging station
V′ Processing station, packaging station
W Path length
w₁ Path section
w₂ Path section
X Section
Y Section

1-19. (canceled)

20. An intermediate storage for products, comprising:
an input station and an output station having a closed conveyor path that is disposed between the input and output stations,
wherein by way of conveying gondolas circulating around the conveyor path the products can be conveyed to the intermediate storage between the input and output stations,
wherein the conveying gondolas can be moved by one or several conveying means of the conveying path,
wherein the output station comprises a movable ejector for ejecting one or several products from the conveying gondolas and a vertically immovably disposed holding device for receiving the ejected products,
wherein the conveyor path comprises at the input station a descending path section with a, during operation, vertical downward movement by the conveying gondolas that are to be loaded with products by the input station,
wherein the conveying path comprises at the output station an ascending path section with a, during operation, vertical upward movement by the conveying gondolas,
wherein the ejector and the holding device are disposed laterally opposite on the ascending path section,
wherein the ejection action of one or several products by the ejector comprises a horizontal forward movement and a horizontal reverse movement,
wherein the horizontal forward and reverse movement is combined with a vertical upward movement by the ejector in such a way that said horizontal and vertical movements by the ejector are synchronized with the upward movement by the conveying gondolas in the ascending path section.

21. An intermediate storage according to claim 20,
wherein the conveyor path comprises in the area of the ascending path section a lateral path between ejector and holding device, and
wherein the horizontal forward and reverse movement is synchronized in the area of the lateral path with the ascending path section.

22. An intermediate storage according to claim 20, wherein the upward movement by the conveying gondolas can be executed continuously in the ascending path section.

23. An intermediate storage according to claim 20, wherein the upward movement by the conveying gondolas can be executed discontinuously in the ascending path section.

24. An intermediate storage according to claim 20,
wherein the holding device is implemented as a conveyor having a circulating conveyor belt for receiving the ejected products and for releasing the products to a processing station, and
wherein the conveyor is rigidly disposed at the output station.

25. An intermediate storage according to claim 20,
wherein the output station comprises a multitude of ejectors for ejecting the products and a multitude of corresponding conveyors for receiving the products, and
wherein the horizontal forward and reverse movement by each ejector is implemented independently of the horizontal forward and reverse motion of each of the other ejectors.

26. An intermediate storage according to claim 20,
wherein the holding device for receiving the products is implemented as a plate, and
wherein the plate can be pivoted or tilted relative to a processing station for releasing the products.

27. An intermediate storage according to claim 25, wherein the holding device comprises plates and conveyors for receiving the products.

28. An intermediate storage according to claim 20, wherein the conveying means are implemented as continuous chains and/or continuous belts.

29. An intermediate storage according to claim 28,
wherein each chain can be driven by at least one drive mechanism or one shaft, and
wherein the one and/or each drive mechanism is controllable and/or adjustable by a control.

30. An intermediate storage according to claim 20,
wherein the synchronization of the vertical upward movement of the conveying gondolas is implemented in the ascending path section by a control, and
wherein sensing means are provided on the ascending path section by which the overlap of the ejector with the path is detectable.

31. An intermediate storage according to claim 20, wherein the synchronization of the vertical upward movement by the conveying gondolas in the ascending path section is implemented by a cam control.

32. A method for unloading conveying objects that are temporarily stored by an intermediate storage, wherein the intermediate storage is disposed between a production station and a processing station, wherein the conveying objects are conveyed from an input station of the intermediate storage by way of the conveying object supports of the latter along a conveyor path to an output station of the intermediate storage, wherein along a vertically ascending path section of the conveying path at the output station of the intermediate storage the conveying objects are at a vertical distance relative to each other, wherein the conveying objects are transferred by a horizontally movable ejector from the output station to a vertically immovably disposed holding device for unloading, wherein the ejector is horizontally and/or vertically movable, and wherein for the transfer from the conveying object support to the holding device the conveying objects at the output station are transferred by a horizontal and/or vertical movement by the ejector, the horizontal and vertical ejection movement by the ejector is synchronized with the upward movement by the conveying object supports along the ascending path section.

33. A method as claimed in claim 32, wherein during the ejection movement by the ejector the conveying object support is moved upward in the ascending path section at a continuous first conveying speed.

34. A method according to claim 33,
wherein during the ejection movement by the ejector the conveying object support is conveyed in the ascending path section at a second conveying speed in order to be conveyed, after the completion of the ejection of the conveying object, at the first conveying speed (SI),
wherein the first conveying speed is larger than the second conveying speed, and
wherein the second conveying speed is larger than zero.

35. A method according to claim 34, wherein during the ejection movement of the conveying object supports in the ascending path section the apparatus is temporarily brought to a halt whereby the second conveying speed is zero.

36. A method according to claim 32,
wherein the conveying object supports are continuously conveyed along the conveyor path, and
wherein the ejector is held at a starting position of a path length, whereby conveying objects at the output station are ejected by the ejector from the conveying object support to the holding device, and that, after the ejection action, the ejector is set into a synchronous vertical upward movement with the conveying objects and a horizontal movement in order to return after having traversed the path length to the starting position, whereby further conveying objects can be ejected.

37. A method according to claim 32,
wherein the conveying object supports are conveyed discontinuously along the conveying path,
wherein during the ejection action of the conveying objects the conveying object support that are to be unloaded is brought to a halt, and
wherein after the completed ejection action the upward motion of the conveying object support is continued.

38. A method as claimed in claim 32, wherein the conveying objects are conveyed along the conveyor path of an object storage.
